(19) United States
(12) Patent Application Publication
(10) Pub. No.: US 2026/0197191 A1
(43) Pub. Date: Jul. 9, 2026

(54) TIME-BASED POWER CAPPING

(71) Applicant: MELLANOX TECHNOLOGIES, LTD., Yokneam (IL)

(72) Inventors: Nir Sucher, Ramat Hashofet (IL); Amit Kazimirsky, Givat-Shmuel (IL); Niv Aibester, Herzliya (IL); Avi Shalom, Tel Aviv (IL)

(21) Appl. No.: 19/009,521

(22) Filed: Jan. 3, 2025

(51) Int. Cl. H04L 12/12; H04L 43/0894

(52) U.S. Cl. CPC H04L 12/12; H04L 43/0894

(57) ABSTRACT

An interconnect device is provided. In one example, an interconnect device includes ports and one or more circuits to monitor an amount of traffic traversing the switch during a time period, determine the amount of traffic within the time period is greater than a threshold, and halting traffic traversing the switch until an end of the time period in response to determining the amount of traffic is greater than the threshold

### FIELD OF THE DISCLOSURE

The present disclosure is generally directed toward networking and, in particular, toward networking devices and methods of operating the same.

### BACKGROUND

Switches and similar network devices represent a core component of many communication, security, and computing networks. Switches are often used to connect multiple devices, device types, networks, and network types.

Devices including but not limited to personal computers, servers, or other types of computing devices, may be interconnected using network devices such as switches. Such interconnected entities form a network that enables data communication and resource sharing among the nodes. While a particular switch may be capable of handling large amounts of data, often, switches do not operate at full capacity. As a result, conventional switches consume amounts of power which may be unnecessarily high during periods of low traffic.

### BRIEF SUMMARY

In accordance with one or more embodiments described herein, a computing system, such as an interconnect device, may enable a diverse range of systems, such as switches, servers, personal computers, and other computing devices, to communicate across a network. Such a computing system, which may be referred to herein as an interconnect device or a switch, may implement one or more power budgets. Implementing a power budget may include monitoring ingress bandwidth, egress bandwidth, and/or power consumption of an interconnect device during a time period, comparing the monitored bandwidth and/or power consumption to one or more thresholds based on the power budget, and, if the bandwidth or the power consumption exceeds the threshold during the time period, halting traffic and putting the interconnect device into a low-power mode such as L1 until the end of the time period. The power budget may be used by the interconnect device to limit power consumption.

The present disclosure describes a system and method for enabling interconnect devices, such as switches or other computing systems, to reduce overall power consumption by offering client devices a feature in which the client devices may be enabled to implement a power budget to be followed by the interconnect devices. Implementations described herein involve the halting of traffic and interconnect devices entering a lower power mode based on power budgets. In some examples, a power budget may set a particular bandwidth or power threshold and a time window.

Processing devices which perform process-intensive tasks such as using machine learning or artificial intelligence models may operate in a manner in which the processing devices perform computational tasks for a period of time before sending data over one or more interconnect devices. During the period of time in which the processing devices perform process-intensive tasks, the interconnect devices may be little used or not used at all. On the other hand, during the period of time in which the processing devices send data over the one or more interconnect devices, the interconnect devices may be used at a high level or a maximum level. Because during normal operation interconnect devices used by processing devices are required for relatively short bursts during which the processing devices are not occupied with processing and are using the interconnect devices for interconnect services, the interconnect devices may be configured to offer periods of high bandwidth capability. During the periods when the interconnect services are less likely to be utilized by the processing devices, the interconnect devices may offer periods of low bandwidth capability.

Embodiments of the present disclosure aim to improve power efficiency and other issues by implementing a power budgeting approach. The power budgeting approach depicted and described herein may be applied to a switch, a router, or any other suitable type of networking device known or yet to be developed. In an illustrative example, a device is disclosed that includes one or more circuits to: monitor an amount of traffic traversing one or more ports of the device during a time period; determine, within the time period, the amount of traffic is greater than and/or equal to a threshold; and in response to determining the amount of traffic is greater than and/or equal to the threshold, halting traffic traversing the one or more ports of the device until an end of the time period.

In another example, a computing node is disclosed that includes computing node comprising one or more circuits to: monitor an amount of traffic traversing the computing node during a time period; determine, within the time period, the amount of traffic is greater than and/or equal to a threshold; and in response to determining the amount of traffic is greater than and/or equal to the threshold, halting traffic traversing the computing node until an end of the time period.

In yet another example, a switch is disclosed that includes one or more communication ports and one or more circuits to: monitor an amount of traffic traversing the switch during a time period; determine, within the time period, the amount of traffic is greater than and/or equal to a threshold; and in response to determining the amount of traffic is greater than and/or equal to the threshold, halting traffic traversing the switch until an end of the time period.

Any of the above example aspects include wherein the threshold is a budget of traffic to traverse the one or more ports within the time period.

Any of the above example aspects include wherein the budget of traffic is determined based on a power budget.

Any of the above example aspects include wherein the power budget is received by the device.

Any of the above example aspects include wherein the one or more circuits are further to, after halting the traffic, enter a low-power mode.

Any of the above example aspects include wherein the one or more circuits are further to, at the end of the time period, exit the low-power mode.

Any of the above example aspects include wherein the one or more circuits are further to, prior to entering the low-power mode, determine an amount of time prior to the end of the time period is greater than and/or equal to a second threshold.

Any of the above example aspects include wherein the one or more circuits are further to, upon determining the amount of traffic is greater than and/or equal to the threshold, determine a time remaining within the time period.

Any of the above example aspects include wherein the one or more circuits are further to, based on the time remaining within the time period, determine a type of low-power mode to enter from among a plurality of types of low-power modes.

Any of the above example aspects include wherein the one or more circuits are further to, at the end of the time period, allow traffic to traverse the one or more ports of the device for a second time period.

Any of the above example aspects include wherein monitoring the amount of traffic traversing the one or more ports of the device comprises using a first counter to count a number of packets traversing the one or more ports of the device and a second counter to track an amount of time left in the time period.

Any of the above example aspects include wherein during the time period the one or more ports of the device consume an amount of power equivalent to a power budget associated with the one or more ports for the time period.

Any of the above example aspects include wherein a second power budget is associated with a second one or more ports of the device.

Additional features and advantages are described herein and will be apparent from the following Detailed Description and the figures.

### BRIEF DESCRIPTION OF THE SEVERAL VIEWS OF THE DRAWINGS

The present disclosure is described in conjunction with the appended figures, which are not necessarily drawn to scale:

FIG. 1 is a block diagram depicting an illustrative configuration of a network in accordance with at least some embodiments of the present disclosure;

FIG. 2 is a block diagram depicting an illustrative configuration of an interconnect device in accordance with at least some embodiments of the present disclosure;

FIG. 3 is a block diagram depicting an illustrative configuration of routing circuitry of an interconnect device in accordance with at least some embodiments of the present disclosure;

FIG. 4 is a graph depicting illustrative power and bandwidth profiles in accordance with at least some embodiments of the present disclosure;

FIG. 5 is a flowchart depicting an illustrative configuration of a method in accordance with at least some embodiments of the present disclosure;

FIG. 6 illustrates an example data center, in accordance with at least one embodiment;

FIG. 7 illustrates a processing system, in accordance with at least one embodiment;

FIG. 8 illustrates a computer system, in accordance with at least one embodiment.

Like reference numbers and designations in the various drawings indicate like elements.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It is understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a printed circuit board (PCB), or the like.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “automatic” and variations thereof, as used herein, refers to any appropriate process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not to be deemed “material.”

The terms “determine,” “calculate,” and “compute,” and variations thereof, as used herein, are used interchangeably, and include any appropriate type of methodology, process, operation, or technique.

Various aspects of the present disclosure will be described herein with reference to drawings that are schematic illustrations of idealized configurations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

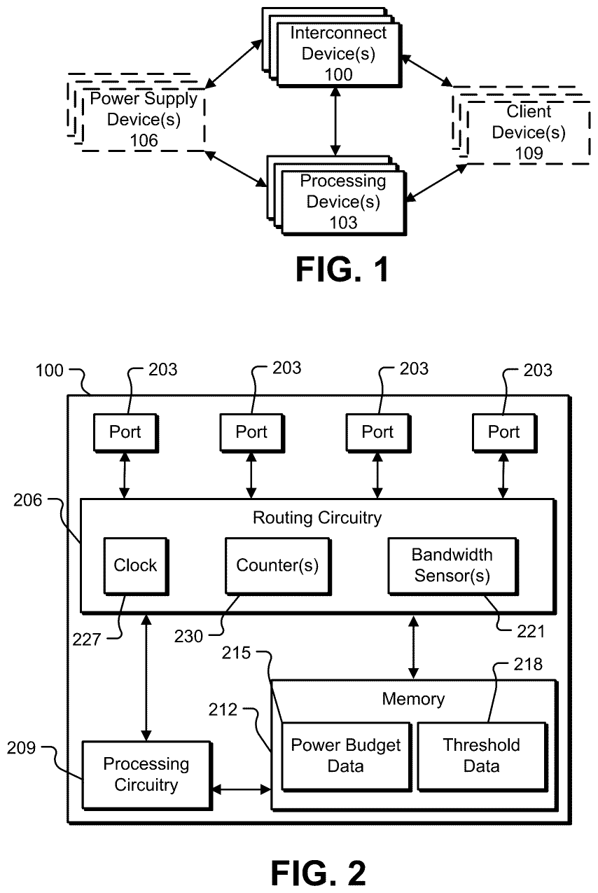

Referring now to FIGS. 1-8, various systems and methods for implementing a power budget in an interconnect device will be described. The concepts of power budgets depicted and described herein can be applied to any type of computing system capable of receiving and/or transmitting data, whether the computing system includes one port or a plurality of ports. Such a computing system may be a switch, but it should be appreciated any type of computing system may be used. The ability of interconnect devices, such as switches, to traverse data is constantly increasing, forwarding packet-processing is becoming more complex as a result power-requirements, and power-density of interconnect devices is increasing.

Since the purpose of an interconnect device may be on-demand packet-forwarding for incoming packets from clients and processing devices, the power envelope from the system side must always support the worst power requirements from the switch, which is a maximum power use-case occurring on most stress packet processing density and bandwidth. With power-budgeting as described herein, a client can chart applicable power budget(s) that are applicable to one or more particular applications with bandwidth or power caps during particular time windows.

As illustrated in FIG. 1, a computing environment as described herein may be a network of processing devices 103 interconnected by interconnect devices 100. One or more interconnect devices 100 may be in communication with one or more processing devices 103. The network of processing devices 103 and interconnect devices 100 may be in communication with one or more client devices 109. The processing devices 103 and interconnect devices 100 may be powered by one or more power supply devices 106. Such a network of processing devices 103 and interconnect devices 100 may be useful in various settings, from data centers and cloud computing infrastructures to artificial intelligence systems.

Processing devices 103 may be computing units, such as personal computers, servers, or other computing devices, and may be responsible for executing applications and performing data processing tasks. Processing devices 103 as described herein can range from servers in a data center to desktop computers in a network, or to devices such as internet of things (IoT) sensors and smart devices.

Each processing device 103 may include one or more processing circuits, such as graphics processing units (GPUs), central processing units (CPUs), data processing units (DPUs), application-specific integrated circuits (ASICs), field programmable gate arrays (FPGAs), or other circuitry capable of performing computations, as well as memory and storage resources to run software applications, handle data processing, and perform specific tasks as required. In some implementations, processing devices 103 may include hardware such as GPUs for handling intensive tasks for machine learning, artificial intelligence (AI) workloads, or other complex processes.

For example, processing devices 103 may operate as a high-performance computing (HPC) cluster. A cluster of processing devices 103 may comprise numerous interconnected servers, each equipped with powerful CPUs and/or GPUs. The processing devices 103 may provide computational horsepower for, as an example, training large-scale AI models or running complex scientific simulations. For AI and machine learning tasks, the processing devices 103 may comprise one or more GPUs or other processing circuitry which may be capable of handling parallel processing requirements of neural networks and other applications.

Interconnect devices 100, as described in greater detail herein, may enable communication between processing devices 103 and/or client devices 109. An interconnect device 100 may be, for example, a switch, a network interface controller (NIC), or other device capable of receiving and sending data, and may act as a central node in the network. Interconnect devices 100 may be wired in a topology including spine switches and top-of-rack (TOR) switches for example. Interconnect devices 100 may be capable of receiving, processing, and forwarding data, e.g., packets, to appropriate destinations within the network, such as processing devices 103 and/or client devices 109. In some implementations, an interconnect device 100 may be included in a switch box, a platform, or a case which may contain one or more interconnect devices 100 as well as one or more power supply devices 106.

In some implementations, each processing device 103 may be connected to one or more ports of one or more interconnect devices 100 via network cables or wirelessly. Processes, such as applications, executed by processing devices 103 may involve transmitting data to nodes of the network, such as to other processing devices 103 and/or to client devices 109. Data may flow through the network of processing devices 103 and interconnect devices 100 using one or more protocols such as transmission control protocol (TCP), user datagram protocol (UDP), or Internet protocol (IP), for example. Each interconnect device 100 may, upon receiving data from a processing device 103 or another interconnect device 100, examine the data to identify a destination for the data and route the data through the network.

Each interconnect device 100 may receive power from a power supply device 106 shared by one or more interconnect devices 100 and/or processing devices 103, from a power supply device 106 contained within the interconnect device 100, or from a power supply device 106 dedicated to the interconnect device 100. A power supply device 106 may comprise a power regulator or other power supply circuitry. In some implementations, a power supply device 106 may supply power to a voltage regulator (VR) which may sustain power as required for a particular interconnect device 100. For example, a VR may sustain 600 watts, although applications executed by an interconnect device 100 may on average consume much less power.

Power supply devices 106 shared by interconnect devices 100 and processing devices 103 may be capable of dynamically redirecting power from interconnect devices to processing devices (and vice versa). For example, when processing devices 103 are performing computations, the processing devices 103 may require less interaction with interconnect devices 100. As a result, while the processing devices 103 may require a greater than average level of processing power, the interconnect devices 100 may require less than average or no power. On the other hand, when processing devices 103 are not performing computational processing, the processing devices 103 may rely on the interconnect devices 100. As a result, while the interconnect devices 100 may require a greater than average level of processing power, the processing devices 103 may require less than average or no power.

When an interconnect device 100 is not actively being used by a processing device 103 to transmit data, the interconnect 100 may enter a standby or low-power mode such as L1. During such times, the interconnect device 100, while consuming less than an average amount of power, may be capable of exiting the low-power mode and receiving, processing, and forwarding a packet when needed. As such, the power supply device 106 may supply interconnect devices 100 sufficient power to meet demands of processing devices 103. The power supply device(s) 106 may be capable of supporting both the interconnect devices 100 and the processing devices 103 with sufficient power to accomplish necessary tasks at the proper times.

Client devices 109 as described herein may be computing devices which, for example, engage in AI-related, research-related, and other processor-intensive tasks, and utilize processing devices 103 to handle the computational loads and data throughput required by such intensive applications. Client devices 109 may include, for example, workstations and personal computers used by researchers, data scientists, and professionals for developing, testing, and running AI models and research simulations. Client devices 109 may include one or more CPUs and/or GPUs but may require additional computational power for complex tasks.

By interacting with processing devices 103, client devices 109 may be enabled to perform functions such as training machine learning models, performing data processing, running simulations, analyzing large datasets, and performing complex data processing tasks, such as data mining, pattern recognition, and predictive modeling, for examples.

An interconnect device 100 as described herein may in some implementations be as illustrated in FIG. 2. Such an interconnect device 100 may include a plurality of ports 203, routing circuitry 206, processing circuitry 209, and memory 212.

The ports 203 of an interconnect device 100 may be capable of facilitating the transmission of data packets, or non-packetized data, into, out of, and through the interconnect device 100. Such ports 203 may serve as interface points where network cables may be connected, connecting the interconnect device 100 with other interconnect devices 100, processing devices 103, and/or client devices 109.

Each port 203 may be capable of receiving incoming data packets from other devices and/or transmitting outgoing data packets to other devices. In some implementations, ports 203 may be configured to operate as either dedicated ingress or egress ports 203 or may be enabled to operate in a dual functionality capable of performing ingress and egress functions. For example, an egress port 203 may be used exclusively for sending data from the interconnect device and an ingress port 203 may be used solely for receiving incoming data into the switch.

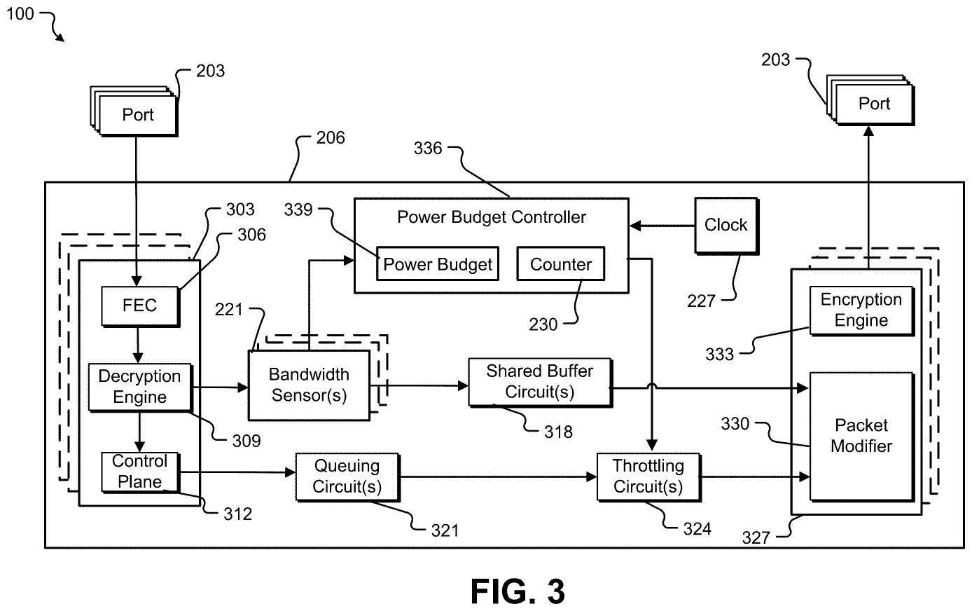

Routing circuitry 206 of an interconnect device 100, as described in greater detail below and in relation to FIG. 3, may be capable of handling a received packet by determining a port from which to send the packet and forwarding the packet from the determined port. Using a system or method as described herein, routing circuitry 206 may be capable of throttling the traversal of data through an interconnect device 100 based on one or more power budgets. As a result, the routing circuitry 206 may be capable of reducing an overall amount of power consumed by the interconnect device 100 without incurring a penalty in processing power.

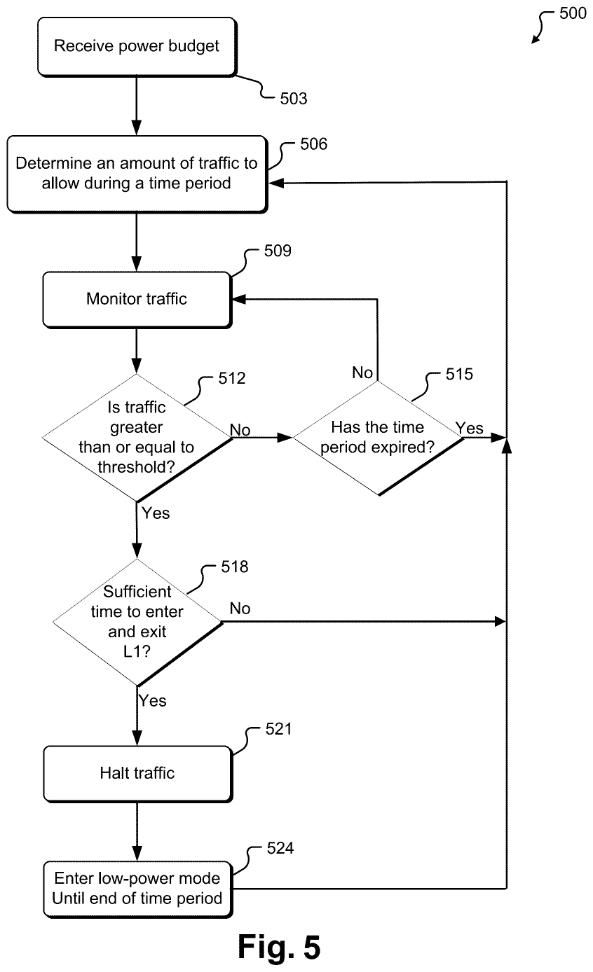

Routing circuitry 206 may include, among other elements as described in greater detail below in relation to FIG. 3, one or more bandwidth sensors 221, a clock 227, and one or more counters 230. The bandwidth sensors 221, clock 227, and counters 230 may be used to implement a method of controlling traffic traversing the interconnect device 100 in accordance with one or more power budgets. Such a method may be as illustrated in FIG. 5 and as described below.

In support of the functionality of the routing circuitry 206, processing circuitry 209 may be configured to control aspects of the routing circuitry 206 to accomplish throttling in relation to power budgets. The processing circuitry 209 may in some implementations include a CPU, an ASIC, and/or other processing circuitry which may be capable of handling computations, decision-making, and management functions required for operation of the interconnect device 100.

Processing circuitry 209 may be configured to handle level management and control functions of the interconnect device 100, such as setting up routing tables, configuring ports, and otherwise managing operation of the interconnect device 100. Processing circuitry 209 may execute software and/or firmware to configure and manage the interconnect device 100, such as an operating system and management tools. In some implementations, the processing circuitry 209 may be configured to receive power budgets from external devices such as processing devices 103 and/or client devices 109. Processing circuitry 209 may be capable of receiving power budgets as described in greater detail below and instructing routing circuitry 206 to function in accordance with one or more power budgets.

The processing circuitry 209 may also be capable of storing power budgets in memory 212 such as in the form of power budget data 215. Power budget data 215 may include power budgets received by the interconnect device 100 and/or power budgets generated by the interconnect device 100. In some implementations, an interconnect device may be configured to process power budget data 215 to generate control instructions capable of being performed by the routing circuitry 206 to enable portions of the interconnect device 100 to enter a low power mode (e.g., L1) when traffic reaches a threshold in accordance with a power budget such as described in greater detail below.

Threshold data 218 may be stored in memory 212 and may be associated with power budgets. For example, and as described in greater detail below, an interconnect device 100 may be configured to implement a power budget by measuring traffic traversing a link. If the traffic reaches a threshold within a time period, and if there is sufficient time left in the time period when the traffic reaches the threshold for the link to enter a low-power mode, the link may enter the low-power mode until the end of the time period (or until a particular time prior to the end of the time period at which point the link may exit the low-power mode).

Memory 212 of an interconnect device 100 as described herein may comprise one or more memory elements capable of storing configuration settings, power budget data 215, threshold data 218, application data, operating system data, and other data. Such memory elements may include, for example, random access memory (RAM), dynamic RAM (DRAM), flash memory, non-volatile RAM (NVRAM), ternary content-addressable memory (TCAM), static RAM (SRAM), and/or memory elements of other formats.

In some implementations, an interconnect device 100 as described herein may include one or more bandwidth sensors 221. A bandwidth sensor 221 as described herein may be a circuit or group of circuits which are configured to measure traffic ingressing one or more particular ports 203. In some implementations, an interconnect device 100 may include one bandwidth sensor 221 for each ingress port 203. A bandwidth sensor 221 as described herein may continuously monitor data flowing into the interconnect device 203 through one or more designated ports 203 and keep track of a rate of data entering the interconnect device 203. For example, a bandwidth sensor 221 may include a counter 230 (such as a packet counter and/or a byte counter) as well as a clock 227 (such as a timer circuit). The bandwidth sensor 221 may be configured to output a number of packets, bytes, or bits received over a given time period (e.g., 10 microseconds). In some implementations, a bandwidth sensor 221 may include one or more registers or memory units in which the bandwidth sensor 221 may store readings. A bandwidth sensor 221 as described herein may be capable of determining whether traffic has met or exceeded a threshold within a given time period. For example, the bandwidth sensor 221 may counter a number of bits, bytes, or packets received during a particular time period. If the number of bits, bytes, or packets received during the particular time period meets or exceeds the threshold, the bandwidth sensor 221 may be configured to output a signal or otherwise alert one or more other components of the interconnect device 100. Data from the bandwidth sensor 221 may be read by, for example, processing circuitry 209, and may be stored in memory 212 or may be read by components of the routing circuitry 206 and used in the performance of processes such as the method 500 as described below.

In some implementations, routing circuitry 206 of an interconnect device 100 as described herein may include one or more counters 230. As described above, a counter 230 may be a part of a bandwidth sensor 221 while in some implementations the counter 230 may be separate from the bandwidth sensor 221. The counter 230 may be a circuit capable of counting a number of bits, bytes, or packets. In some implementations, the counter 230 may receive bandwidth data from a bandwidth sensor 221 and, based on the bandwidth data, counter a number of bits, bytes, or packets received. An interconnect device 100 may include separate counters 230 for each port 203 in some implementations. Data from the counter(s) 230 may be ready by, for example, processing circuitry 209, and may be stored in memory 212.

In some implementations, routing circuitry 206 of an interconnect device 100 as described herein may include one or more clocks 227. As described above, a clock 227 may be a part of a bandwidth sensor 221 while in some implementations the clock 227 may be separate from the bandwidth sensor 221. The clock 227 may be a circuit capable of counting time. In some implementations, the clock 227 may receive data from another clock or timer. The clock 227 may be configured to count time up to a predetermined or configured time period. Upon reaching the time period, the clock 227 may reset to zero and begin counting back up to the time period. An interconnect device 100 may, as described in greater detail herein, use the clock 227 to determine whether traffic associated with one or more ports has reached a threshold within the time period. In some implementations, an interconnect device may use one clock 227 for a number of bandwidth sensors 221 and/or counters 230 or may use separate clocks 227 for different bandwidth sensors 221 and/or counters 230.

FIG. 3 illustrates elements of routing circuitry 206 of an interconnect device 100 in accordance with one or more implementations of the present disclosure. One or more ingress ports 203 may, upon receiving data, transmit the data to one or more ingress processing circuits 303. In some implementations, each ingress port 203 may be associated with a dedicated ingress processing circuit 303, while in other implementations, multiple ingress ports 203 may share an ingress processing circuit 303.

Each ingress processing circuit 303 may include one or more of a forward error correction (FEC) circuit 306, a decryption engine circuit 309, a control plane 312, and/or other circuits and components which may handle ingress packets and non-packetized ingress data. An FEC circuit 306 as described herein may be used to perform error detection and correction for packets received from a port 203 before the packets are directed to an egress port 203. The FEC circuit 306 may receive ingress data from a port 203 and, after performing FEC, output the received ingress data or a processed version of the ingress data to a decryption engine circuit 309.

A decryption engine circuit 309 as described herein may be used to decrypt all or a portion of received packets to enable the interconnect device 100 to determine a port 203 from which to send each packet. The decryption engine circuit 309 may be capable of ensuring that sensitive data remains protected from unauthorized access during traversal of the data through the interconnect device 100. The decryption engine circuit 309 may output received packets or data associated with received packets to one or more shared buffer circuits 318 via a bandwidth sensor 221. The decryption engine circuit 309 may also output data associated with received packets to the control plane 312.

A control plane 312 as described herein may be used to manage how received data packets are forwarded and handled within the interconnect device 100. The control plane 312 may receive data associated with a received packet from the decryption engine circuit 309 and, based on the data associated with received packet, write instructions to one or more queueing circuits 321 as described below.

Each of the FEC circuit 306, decryption engine circuit 309, control plane 312, and/or other circuits and components of the ingress processing circuits 303 may include one or more of an ASIC, FPGA, digital signal processor (DSP), network processor, accelerator, hardware secure module, CPU, and/or other components and circuits capable of performing ingress processing. As should be appreciated, each ingress processing circuit 303 of an interconnect device 100 may include one or more additional circuits and components in addition to or instead of the FEC circuit 306, decryption engine circuit 309, and control plane 312 described above.

Each ingress processing circuit 303 of the interconnect device 100 may be enabled to write data to a shared-buffer circuit 318 and a queueing circuit 321. Packets to be egressed from the interconnect device 100 may be stored in the shared-buffer circuit 318.

Data to be sent from the interconnect device 100 may be processed by one or more egress processing circuits 327. In some implementations, each port 203 which is used for egress may be associated with a dedicated egress processing circuit 327. In other implementations, multiple egress ports 203 may share one or more egress processing circuits 327. Data which may be used by egress processing circuits 327 to route packets to egress ports 203 may be written to the queuing circuits 321. Once a queueing circuit 321 assigns a particular packet to a particular egress port 203, packet data stored in the shared buffer circuit 318 may be read by an egress processing circuit 327 associated with the particular egress port 203.

An egress processing circuit 327 may include, but should not be considered as limited to, a packet modifier 330 and an encryption engine 333. A packet modifier 330 as described herein may include circuitry such as an ASIC, an FPGA, or other componentry capable of adjusting packets before the packets are transmitted from the interconnect device. Such adjustments may include, for example, the adding or removal of tags, modification of settings and packet header data, and other modifications. An encryption engine 333 as described herein may include circuitry such as an ASIC, an FPGA, or other componentry capable of encrypting packets before the packets are transmitted from the interconnect device. Such encryption may include, for example, use of encryption algorithms such as Advanced Encryption Standard (AES), RSA, or other algorithms.

After being processed by an egress processing circuit 327, a packet may be transmitted from the interconnect device 100 via an egress port 203. The egress port 203 may be directly connected to an ultimate destination of the packet or may be connected to another interconnect device 100 which may forward the packet towards the ultimate destination.

As described above, routing circuitry 206 of an interconnect device 100 may be capable of throttling the traversal of data through the interconnect device 100 based on one or more power budgets. As a result, the routing circuitry 206 may be capable of reducing an overall amount of power consumed by the interconnect device 100 without incurring a penalty in processing power.

The reduction of the overall power consumption of the interconnect device 100 may be achieved through the use of one or more power budget controllers 336. A power budget controller 336 may be one or more of, or a combination of, ASICs, FPGAs, and other componentry capable of performing the functions of the power budget controller 336 as described herein.

A power budget controller 336 may be capable of measuring bandwidth, such as through the use of a bandwidth sensor 221, and throttling data traversing the interconnect device 100, such as through the use of one or more throttling circuits 324 as described below. A power budget controller 336 may include or be in communication with one or more power budgets 339, one or more counters 230, and/or one or more bandwidth sensors 221.

The interconnect device 100, using a power budget controller 336, may be enabled to govern or regulate power consumption based on one or more power budgets. In some implementations, power budgets may be provided to the power budget controller 336 by processing circuitry 209 of the interconnect device 100. For example, in some implementations, a user may be enabled to set one or more power consumption limits or thresholds and/or bandwidth limits or thresholds. Users may, such as by interacting with client devices 109 and/or processing devices 103, be enabled to set such power consumption limits or thresholds and/or bandwidth limits or thresholds manually or such power consumption limits or thresholds and/or bandwidth limits or thresholds may be set automatically by client devices 109 and/or processing devices 103. In some implementations, in addition to or instead of user-defined thresholds, thresholds may be automatically set based on various performance demands. For example, thresholds may be defined by one or more optimization algorithms and/or artificial intelligence models which may be capable of monitoring bandwidth and/or power consumption and dynamically adjusting threshold amounts and/or threshold durations.

A power budget controller 336 may be configured to control or manage bandwidth of data traversing the interconnect device 100. For example, a power budget controller 336 may control one or more throttling circuits 324 of the interconnect device 100. Controlling a throttling circuit 324 may involve switching the throttling on and off or adjusting an amount of throttling at particular moments in time. The timing of and/or amounts of throttling may be dependent on various thresholds and thresholds may be dependent on power budgets in effect as described herein.

An interconnect device 100 may in some implementations include a plurality of power budget controllers 336. In some implementations a power budget controller 336 may be associated with a particular power budget and/or a particular threshold bandwidth. For example, one interconnect device 100 may be configured to implement a number of power budgets and each power budget may be associated with a respective power budget controller 336. In some implementations a power budget controller 336 may be associated with a particular port 203 and each ingress port 203 may be associated with a respective power budget controller 336.

The power budget controller 336 may be enabled to measure the bandwidth traversing the interconnect device 100, such as by using a bandwidth sensor 221. While the routing circuitry 206 illustrated in FIG. 3 includes a bandwidth sensor 221 between the decryption engine and the shared buffer circuit 318, it should be appreciated that the bandwidth sensor 221 may be in other positions within or outside of the routing circuitry 206 and that the power budget controller 336 may be enabled to measure bandwidth at various points along the path from the ingress port 203 to the egress port 203. For example, the bandwidth sensor 221 may be capable of measuring ingress bandwidth and/or egress bandwidth.

Using the bandwidth sensor 221, the power budget controller 336 may be enabled to measure an amount of bandwidth per ingress port 203. In some implementations, each ingress port 203 or ingress processing circuit 303 may be enabled to report its respective bandwidth to the power budget controller 336. The power budget controller 336 may be enabled to monitor, in real-time, the bandwidth that traverses the interconnect device 100 at every given minute.

In some implementations, a bandwidth sensor 221 may be enabled to be used by the power budget controller 336 to measure an amount of bandwidth per egress port 203. For example, each egress port 203 or egress processing circuit 327 may be enabled to report its respective egress bandwidth to the power budget controller 336 via a respective bandwidth sensor 221.

Each power budget controller 336 may be configured to a particular threshold and can cause traffic to halt, if necessary, as described below. The throttling circuits 324 may be enabled to cause scheduling of packets to the egress processing circuit 327 to cease or to occur at a lesser rate. For example, when a bandwidth measured by a bandwidth sensor 221 meets or exceeds a threshold within a particular period of time according to a power budget, a power budget controller 336 may control throttling circuits 324 to stop traffic from being egressed and cause one or more components of the interconnect device 100 to enter a low-power mode.

In some implementations, the throttling circuits 324 may be enabled to throttle traffic on the ingress side and/or the egress side of the routing circuitry 206. Whether the throttling is performed on the egress side or the ingress side or both may depend on factors such as whether the traffic is lossy or lossless.

The budget in effect may change over time according to instructions received by the interconnect device 100 as described below. A power budget controller 336 may be enabled to control traffic using a specific threshold power and/or bandwidth and/or a specific time period.

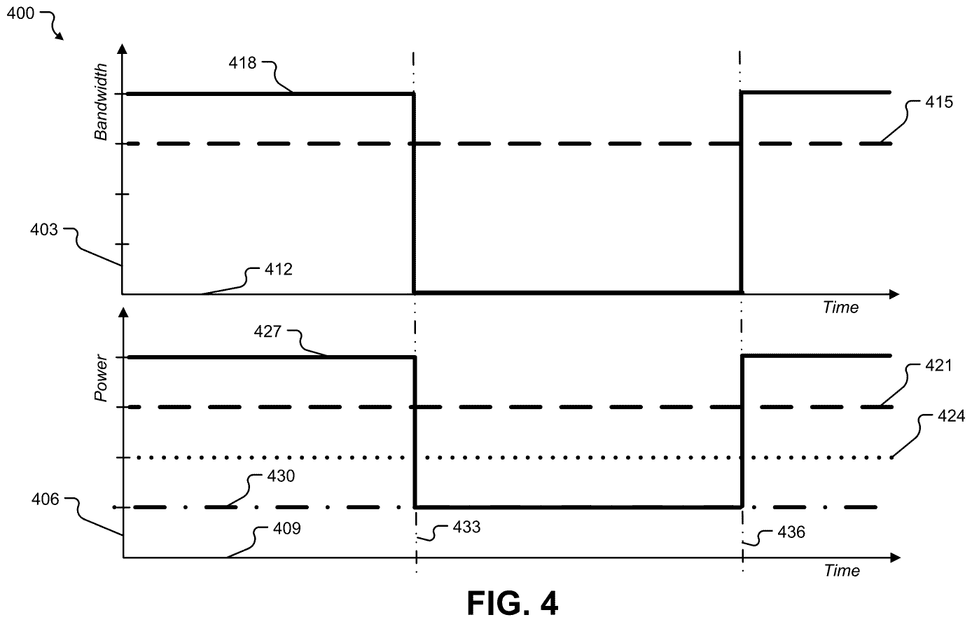

An example power budget 400 as may be implemented by a power budget controller 336 is illustrated in FIG. 4 alongside a conventional power profile. To illustrate the example power budget 400, bandwidth is plotted on a first vertical axis 403, power is plotted on a second vertical axis 406, and time is plotted on the horizontal axes 409, 412.

The dotted line 424 on the power axis 406 illustrates normal idle power of an active link. The dash-dotted line 430 on the power axis 406 illustrates idle power of a link in low-power mode (e.g., L1).

The dashed line 415 on the bandwidth axis 403 illustrates bandwidth of a conventional process of throttling of traffic at a constant bandwidth. The dashed line 421 on the power axis 406 illustrates the power consumption of the same conventional throttling of traffic. The solid line 418 on the bandwidth axis 403 illustrates bandwidth of an example process as described herein. The solid line 427 on the power axis 406 illustrates power consumption of the same example process as described herein.

In the example process illustrated by the solid line 418 on the bandwidth axis 403 and the solid line 427 on the power axis 406, the bandwidth is allowed to traverse the interconnect device at a maximum level from the origin of the time axes 409, 412. At a first moment in time 433, a power budget controller 336 determines a threshold amount of traffic according to a power budget in effect has been reached and halts the traffic, such as by using a throttling circuit 324. The power budget in effect also, in the example process, indicates a time period which lasts from the origin of the time axes 409, 412 until a moment in time 436. At the end of the time period, the power budget controller 336 may enable traffic to again traverse at the maximum level. As should be appreciated, during the time that the traffic is halted, power consumption drops to a minimal level, equal to power consumption during the low-power mode as indicated by the dash-dotted line 430.

A power budget, such as the power budget 400 illustrated in FIG. 4, may be created by a user, such as users of client devices 109, or may be created automatically, such as by applications executed by client devices 109 and/or processing devices 103. For example, a user or application may be enabled to set a threshold bandwidth or a threshold power consumption amount and set a time period. Through the creation of particular power budgets, any desired average power consumption level for an interconnect device 100 can be achieved.

As packets are processed by ingress processing circuit(s) 303 and egress processing circuit(s) 327, power is consumed by components such as FEC circuit(s) 306, decryption engine circuit(s) 309, control plane(s) 312, packet modifier(s) 330, and encryption engine(s) 333. When higher amounts of bandwidth are traversing an interconnect device 100, the interconnect device 100 may consume greater amounts of power as compared to when lower amounts of bandwidth are traversing the interconnect device 100. The amount of power consumed by an interconnect device 100 may be in direct correlation with the amount of bandwidth traversing the interconnect device 100.

While the power budget illustrated in FIG. 4 is described as using a bandwidth threshold, it should be appreciated that in some implementations a power budget may set a particular power threshold. That is, a power budget may indicate a threshold amount of power. If power consumed by the interconnect device 100 exceeds the threshold amount of power within a particular period of time, throttling of data traversing the interconnect device 100 may occur, resulting in less data traversing the interconnect device 100 and, as a result, less power consumed by the interconnect device 100.

As illustrated in FIG. 5, an example method 500 may be implemented by an interconnect device 100 as described herein to enable power consumption control based on one or more power budgets. As described above, an interconnect device 100 may be, for example, a switch or other type of computing system capable of receiving and forwarding data in a network. The interconnect device 100 may be utilized by one or more processing devices 103 and/or client devices 109 to provide interconnect services with one or more other processing devices 103 and/or client devices 109. The interconnect device 100 may receive power from one or more power supply devices 106. Such power supply devices 106 may be comprised by the interconnect device 100 or may be shared by a plurality of interconnect devices 100, processing devices 103, and/or client devices 109.

At 503, the interconnect device 100 may receive a power budget. The power budget may be received by processing circuitry 209 of the interconnect device 100, such as via a port 203, and may be sent to the interconnect device 100 from an application executing on a processing device for example. In some implementations, a power budget may be programmed by a system administrator or other user. In other implementations, a power budget may be automatically generated by an interconnect device 100 based on network conditions or other factors. A power budget may be stored in memory 212 of an interconnect device 100 as power budget data 215. A power budget may also or alternatively be hard-wired into the routing circuitry 206 through dedicated components such as a clock 227, counters 230, and/or bandwidth sensor(s) 221. The power budget may indicate a length of a time period (i.e., an amount of time) and one or more of a power threshold and a bandwidth threshold. The time period may be an amount of time during which traffic traversing a particular port or group of ports may be allowed to reach a threshold level. The threshold level may be in terms of a number of bits, bytes, or packets. As described below, once the traffic traversing the particular port or group of ports reaches the threshold level a power budget controller 336 may halt traffic using one or more throttling circuits 324 if there is sufficient time for components of the routing circuitry 206 to enter and exit a low power mode.

The method 500 may be particularly useful in cases where particular applications operate in a manner such that the applications do not require full bandwidth at all times. For example, an application may utilize the processing devices 103 to perform a computationally intensive task. The task may require processing devices 103 to perform processing functions and to interact with other processing devices 103 and/or client devices 109 via one or more interconnect devices 100. The power budget may specify a particular amount of traffic over a particular amount of time (e.g., a number of milliseconds) which the application requires for operation. The time window to implement the power budget may be a repeating time window. For example, once the time window expires, the time window may restart and the counting of bandwidth or power may reset for the next time window. In some implementations, the time window may be a unique time window and a different time window may follow. A power budget may also specify an amount of bandwidth or power which may be allowed during the specified amount of time. For example, the power budget may specify threshold amount of bandwidth or power which may be used by the interconnect device to determine the thresholds to put into effect when implementing the power budgets as described herein.

In some implementations, a power budget may be applied to a plurality of ports 203 of an interconnect devices 100. For example, an overarching or governing power budget may be implemented such that each of (or a subset of) the ports of an interconnect device 100 executes the same or similar power budgets. Such implementations may utilize one or more power budget controller 336 as illustrated in FIG. 3. In some implementations, each port of the interconnect devices 100 may operate following a unique power budget. A single power budget controller 336 may be configured to halt traffic for multiple ports 203 in some implementations while in other implementations each port 203 may be associated with a unique power budget controller 336.

A power budget may be one of a plurality of power budgets. For example, the interconnect device 100 may receive a plurality of power budgets from one or more processing devices 103 and/or client devices 109. In some implementations, the power budgets may be run in a series, with a new power budget being implemented once a time period for a preceding power budget expires.

At 506, the interconnect device may determine, based on the power budget, an amount of traffic to allow during a particular time period. In some implementations, the interconnect device may be configured to calculate the amount of traffic to allow by dividing an amount of traffic indicated by the power budget into smaller sets. For example, a power budget may indicate a threshold of ‘A’ packets over ‘B’ seconds. The interconnect device may divide the ‘B’ seconds by ‘C’ to generate ‘C’ shorter periods of time of length ‘D.’ The number of shorter periods of time ‘C’ may be set by user configuration settings or may be determined by the interconnect device 100 as a number such as to arrive at periods of time of a specific length or a range of specific lengths. For example, the interconnect device 100 may divide a time period indicated by a power budget into time periods of a desired time period over which to control the traffic. The interconnect device may next determine an amount of traffic to allow during each of the ‘C’ shorter periods of time of length ‘D’ by dividing the initial threshold of ‘A’ packets by ‘C’ to generate smaller thresholds of ‘E’ packets for each of the ‘C’ shorter periods of time.

At 509, the interconnect device may monitor one or more of an ingress bandwidth and power consumption. Monitoring ingress bandwidth as described herein may involve measuring the rate at which data packets enter the interconnect device 100 via one or more ingress ports 203. In some implementations, the bandwidth may be measured on a per-port basis and the per-port bandwidth measurements may be aggregated to reach a total ingress bandwidth. As illustrated in FIG. 3, in some implementations, the bandwidth measurement may take place at a point between an ingress processing circuit 303 and a shared buffer circuit 318. For example, packets may be sent from a decryption engine circuit 309 of the ingress processing circuit 303 associated with a particular port to the shared buffer circuit 318. A bandwidth sensor 221 may be used by a power budget controller 336 to track the bandwidth. It should be appreciated, however, that the bandwidth measurement may occur at other places along the path data takes as it traverses the interconnect device 100.

The monitoring of bandwidth may be accomplished through sampling data flow at one or more points in the interconnect device 100 at regular intervals (e.g., every microsecond), tracking a real-time bandwidth for each ingress port 203, using statistical sampling, or any other method for determining or estimating a rate of data traversing the interconnect device 100.

Monitoring power consumption as described herein may involve a power budget controller 336 reading data from a power supply sensor. For example, a power supply sensor may be a current sensor, a voltage sensor, a power meter, or other device, and may be used to determine a current amount of amperage drawn by the interconnect device 100 at any given time. Similar to measuring bandwidth as described above, a power supply sensor may be read at intervals or in real time. In some implementations, the power budget controller 336 may be configured to determine a moving average power consumption or may simply monitor the actual power consumption over time.

While the systems and methods described herein are described as including monitoring bandwidth and/or power consumption, it should be appreciated that in some implementations other resources may be monitored in addition to or instead of bandwidth and power consumption. Such resources may include, for example, packet-rates, buffer utilization, queue length, and/or any other type of resource which may be monitored in a device. The systems and methods described herein regarding using monitored bandwidths and/or power consumptions may be performed in such a way as to include monitoring any other such resources instead of or in addition to bandwidth and/or power consumption.

At 512, the power budget controller 336 may determine whether traffic during the time period has become greater than or equal to a threshold. For example, the power budget controller 336 may determine whether an ingress bandwidth exceeds a bandwidth threshold and/or power consumption of the interconnect device 100 exceeds a power threshold. The time period may begin at 509 when traffic monitoring begins. As time elapses, the power budget controller 336 may track data ingressing a particular port. During the time period, the traffic ingressing the port may be summed to determine a total amount of traffic having entered the port during the time period. If, during the time period, the total amount of traffic having entered the port meets or exceeds the threshold according to the power budget, the method 500 includes proceeding to the step of 518 in which the power budget controller 336 determines whether there is sufficient time to enter and exit L1. If the total amount of traffic having entered the port fails to meet or exceed the threshold during the time period, the method 500 includes proceeding to the step of 515 in which the power budget controller 336 determines whether the time period has expired.

At 515, if the traffic entering the port has not yet reached the threshold during the time period, then the method 500 may include continuing to monitor the traffic at 509 until the time period has elapsed. If the time period has elapsed at 515, then the method 500 may end or return to 506.

At 518, the interconnect device 100 may determine whether sufficient time exists in the time period to enter and exit a low power mode (e.g., L1). For example, entering a low power mode may require a known or estimated duration of time (e.g., ten microseconds). Similarly, exiting the low power mode may require a known or estimated duration of time (e.g., ten microseconds). In some implementations, the interconnect device 100 may be enabled to select a particular low power mode to enter from a number of different low power modes. The low power mode may be selected based at least in part on an amount of time remaining in the time period when the traffic reaches the threshold. A deep low power mode may require a greater amount of time to enter and exit as compared to a less deep low power mode. If there is sufficient time to enter the deeper low power mode, the interconnect device may select the deeper low power mode. If there is not sufficient time to enter the deeper low power mode but there is sufficient time to enter the less deep low power mode, then the interconnect device may select the less deep low power mode. If there is not sufficient time to enter a low power mode, then the method 500 may end or return to 506 and determine a new amount of traffic to allow during a next time period.

At 521, if there is sufficient time to enter and exit a low power mode, the interconnect device 100 may halt traffic at 521 and enter low power mode at 524 until the end of the time period. At the end of the time period, the method 500 may end or return to 506 and determine a new amount of traffic to allow during a next time period. When the method 500 returns to 506, the interconnect device may determine a new threshold and/or a new duration of a time period in which to monitor traffic. Determining the new threshold and/or duration may involve receiving a new power budget or identifying a power budget to initiate.

In some implementations, different power budgets and/or thresholds may be applied to different ports. For example, a first power budget may be applied to ports designated as high priority and may allow for relatively greater amounts of bandwidth and/or power consumption by such ports, while a second power budget may be applied to ports designated as low priority and may allow for relatively less bandwidth and/or power consumption by such low priority ports. As should be appreciated, different power budgets may be in effect at any given time in an interconnect device 100 and each power budget may be applied to one or more particular ports to provide for greater system flexibility and to reduce overall power consumption without affecting all flows and/or all ports traversing the interconnect device 100.

Also, in some implementations, different power budgets may be in effect for different applications which utilize the interconnect device 100. For example, one or more processing devices 103 may execute multiple applications which involve transmitting data via an interconnect device 100. Each such application may be associated with a particular power budget. The interconnect device 100 may be enabled to implement each power budget associated with each application simultaneously such that the interconnect device 100 is capable of providing the required bandwidth and/or power consumption for each application as needed.

The present disclosure encompasses methods with fewer than all of the steps identified in FIG. 5 (and the corresponding description of the method 500), as well as methods that include additional steps beyond those identified in FIG. 5 (and the corresponding description of the method 500). The present disclosure also encompasses methods that comprise one or more steps from the methods described herein, and one or more steps from any other method described herein.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. The systems and methods described herein may be used in augmented reality, virtual reality, mixed reality, robotics, security and surveillance, autonomous or semi-autonomous machine applications, and/or any other technology spaces in which one or more signal conductors may have at least two different states that consume different amounts of power.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, web-hosted services or web-hosted platforms, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, systems for implementing web-hosted services (e.g., for program optimization at runtime) or web-hosted platforms (e.g., integrated development environments that include program optimization as a service), as an application programming interface (“API”) between two or more separate applications or systems, and/or other types of systems.

### Data Center

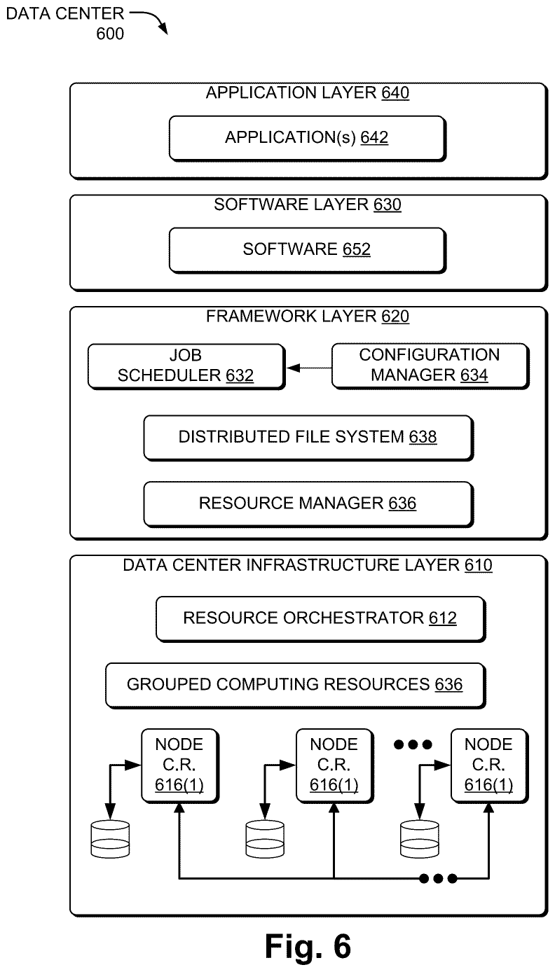

FIG. 6 illustrates an example data center 600, in accordance with at least one embodiment. In at least one embodiment, data center 600 includes, without limitation, a data center infrastructure layer 610, a framework layer 620, a software layer 630 and an application layer 640.

In at least one embodiment, as shown in FIG. 6, data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (“CPUs”) or other processors (including accelerators, field programmable gate arrays (“FPGAs”), data processing units (“DPUs”) in network devices, graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R. s 616(1)-616(N) may be a server having one or more of above-mentioned computing resources.

In at least one embodiment, grouped computing resources 614 may include separate groupings of node C.R. s housed within one or more racks (not shown), or many racks housed in data centers at various geographical locations (also not shown). Separate groupings of node C.R.s within grouped computing resources 614 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 612 may configure or otherwise control one or more node C.R.s 616(1)-616(N) and/or grouped computing resources 614. In at least one embodiment, resource orchestrator 612 may include a software design infrastructure (“SDI”) management entity for data center 600. In at least one embodiment, resource orchestrator 612 may include hardware, software or some combination thereof.

In at least one embodiment, as shown in FIG. 6, framework layer 620 includes, without limitation, a job scheduler 632, a configuration manager 634, a resource manager 636 and a distributed file system 638. In at least one embodiment, framework layer 620 may include a framework to support software 652 of software layer 630 and/or one or more application(s) 642 of application layer 640. In at least one embodiment, software 652 or application(s) 642 may respectively include web-based service software or applications, such as those provided by Amazon Web Services, Google Cloud and Microsoft Azure. In at least one embodiment, framework layer 620 may be, but is not limited to, a type of free and open-source software web application framework such as Apache Spark™ (hereinafter “Spark”) that may utilize distributed file system 638 for large-scale data processing (e.g., “big data”). In at least one embodiment, job scheduler 632 may include a Spark driver to facilitate scheduling of workloads supported by various layers of data center 600. In at least one embodiment, configuration manager 634 may be capable of configuring different layers such as software layer 630 and framework layer 620, including Spark and distributed file system 638 for supporting large-scale data processing. In at least one embodiment, resource manager 636 may be capable of managing clustered or grouped computing resources mapped to or allocated for support of distributed file system 638 and job scheduler 632. In at least one embodiment, clustered or grouped computing resources may include grouped computing resource 614 at data center infrastructure layer 610. In at least one embodiment, resource manager 636 may coordinate with resource orchestrator 612 to manage these mapped or allocated computing resources.

In at least one embodiment, software 652 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. In at least one or more types of applications may include, without limitation, CUDA applications.

In at least one embodiment, any of configuration manager 634, resource manager 636, and resource orchestrator 612 may implement any number and type of self-modifying actions based on any amount and type of data acquired in any technically feasible fashion. In at least one embodiment, self-modifying actions may relieve a data center operator of data center 600 from making possibly bad configuration decisions and possibly avoiding underutilized and/or poor performing portions of a data center.

In at least one embodiment, the data center 600 may be used to implement the interconnect devices 100 and/or the processing devices 103 (see FIG. 1). For example, the interconnect devices 100 and/or the processing devices 103 may include one or more of the grouped computing resources 614 and/or one or more of the C.R.s 616(1)-616(N). In at least one embodiment, one or more systems depicted in FIG. 6 are utilized to implement one or more systems and/or processes such as those described in connection with FIGS. 1-5.

### Computer-Based Systems

The following figures set forth, without limitation, example computer-based systems that can be used to implement at least one embodiment.

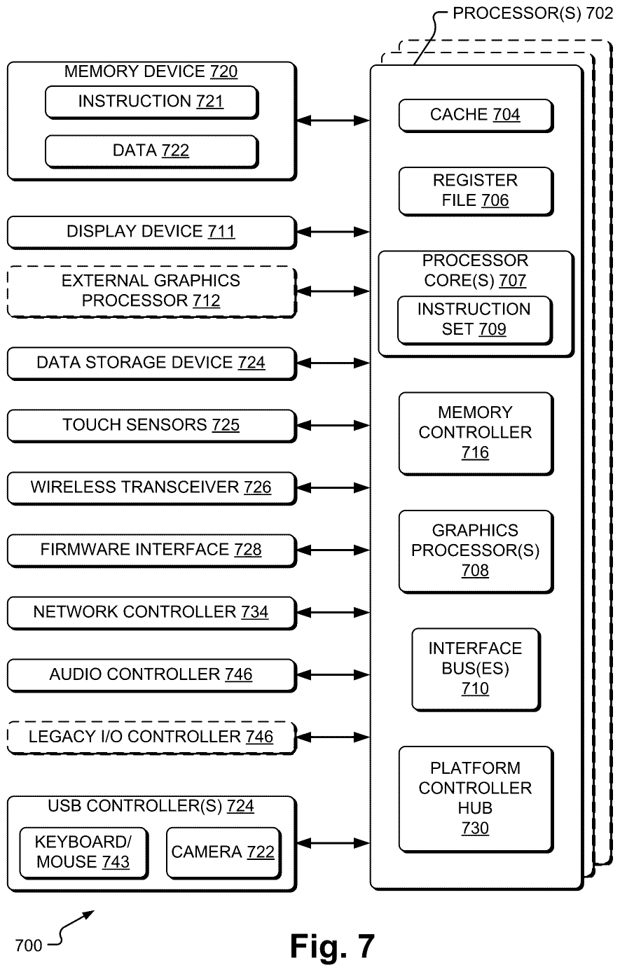

FIG. 7 illustrates a processing system 700, in accordance with at least one embodiment. In at least one embodiment, processing system 700 includes one or more processors 702 and one or more graphics processors 708, and may be a single processor desktop system, a multiprocessor workstation system, or a server system having a large number of processors 702 or processor cores 707. In at least one embodiment, processing system 700 is a processing platform incorporated within a system-on-a-chip (“Sort”) integrated circuit for use in mobile, handheld, or embedded devices.

In at least one embodiment, processing system 700 can include, or be incorporated within a server-based gaming platform, a game console, a media console, a mobile gaming console, a handheld game console, or an online game console. In at least one embodiment, processing system 700 is a mobile phone, smart phone, tablet computing device or mobile Internet device. In at least one embodiment, processing system 700 can also include, couple with, or be integrated within a wearable device, such as a smart watch wearable device, smart eyewear device, augmented reality device, or virtual reality device. In at least one embodiment, processing system 700 is a television or set top box device having one or more processors 702 and a graphical interface generated by one or more graphics processors 708.

In at least one embodiment, one or more processors 702 each include one or more processor cores 707 to process instructions which, when executed, perform operations for system and user software. In at least one embodiment, each of one or more processor cores 707 is configured to process a specific instruction set 709. In at least one embodiment, instruction set 709 may facilitate Complex Instruction Set Computing (“CISC”), Reduced Instruction Set Computing (“RISC”), or computing via a Very Long Instruction Word (“VLIW”). In at least one embodiment, processor cores 707 may each process a different instruction set 709, which may include instructions to facilitate emulation of other instruction sets. In at least one embodiment, processor core 707 may also include other processing devices, such as a digital signal processor (“DSP”).

In at least one embodiment, processor 702 includes cache memory (‘cache”) 704. In at least one embodiment, processor 702 can have a single internal cache or multiple levels of internal cache. In at least one embodiment, cache memory is shared among various components of processor 702. In at least one embodiment, processor 702 also uses an external cache (e.g., a Level 3 (“L3”) cache or Last Level Cache (“LLC”)) (not shown), which may be shared among processor cores 707 using known cache coherency techniques. In at least one embodiment, register file 706 is additionally included in processor 702 which may include different types of registers for storing different types of data (e.g., integer registers, floating point registers, status registers, and an instruction pointer register). In at least one embodiment, register file 706 may include general-purpose registers or other registers.

In at least one embodiment, one or more processor(s) 702 are coupled with one or more interface bus(es) 710 to transmit communication signals such as address, data, or control signals between processor 702 and other components in processing system 700. In at least one embodiment interface bus 710, in one embodiment, can be a processor bus, such as a version of a Direct Media Interface (“DMI”) bus. In at least one embodiment, interface bus 710 is not limited to a DMI bus and may include one or more Peripheral Component Interconnect buses (e.g., “PCI,” PCI Express (“PCIe”)), memory buses, or other types of interface buses. In at least one embodiment processor(s) 702 include an integrated memory controller 716 and a platform controller hub 730. In at least one embodiment, memory controller 716 facilitates communication between a memory device and other components of processing system 700, while platform controller hub (“PCH”) 730 provides connections to Input/Output (“I/O”) devices via a local I/O bus.

In at least one embodiment, memory device 720 can be a dynamic random-access memory (“DRAM”) device, a static random-access memory (“SRAM”) device, flash memory device, phase-change memory device, or some other memory device having suitable performance to serve as processor memory. In at least one embodiment memory device 720 can operate as system memory for processing system 700, to store data 722 and instructions 721 for use when one or more processors 702 executes an application or process. In at least one embodiment, memory controller 716 also couples with an optional external graphics processor 712, which may communicate with one or more graphics processors 708 in processors 702 to perform graphics and media operations. In at least one embodiment, a display device 711 can connect to processor(s) 702. In at least one embodiment display device 711 can include one or more of an internal display device, as in a mobile electronic device or a laptop device or an external display device attached via a display interface (e.g., DisplayPort, etc.). In at least one embodiment, display device 711 can include a head mounted display (“HMD”) such as a stereoscopic display device for use in virtual reality (“VR”) applications or augmented reality (“AR”) applications.

In at least one embodiment, platform controller hub 730 enables peripherals to connect to memory device 720 and processor 702 via a high-speed I/O bus. In at least one embodiment, I/O peripherals include, but are not limited to, an audio controller 746, a network controller 734, a firmware interface 728, a wireless transceiver 726, touch sensors 725, a data storage device 724 (e.g., hard disk drive, flash memory, etc.). In at least one embodiment, data storage device 724 can connect via a storage interface (e.g., SATA) or via a peripheral bus, such as PCI, or PCIe. In at least one embodiment, touch sensors 725 can include touch screen sensors, pressure sensors, or fingerprint sensors. In at least one embodiment, wireless transceiver 726 can be a Wi-Fi transceiver, a Bluetooth transceiver, or a mobile network transceiver such as a 3G, 4G, or Long Term Evolution (“LTE”) transceiver. In at least one embodiment, firmware interface 728 enables communication with system firmware, and can be, for example, a unified extensible firmware interface (“UEFI”). In at least one embodiment, network controller 734 can enable a network connection to a wired network. In at least one embodiment, a high-performance network controller (not shown) couples with interface bus 710. In at least one embodiment, audio controller 746 is a multi-channel high definition audio controller. In at least one embodiment, processing system 700 includes an optional legacy I/O controller 740 for coupling legacy (e.g., Personal System 2 (“PS/2”)) devices to processing system 700. In at least one embodiment, platform controller hub 730 can also connect to one or more Universal Serial Bus (“USB”) controllers 742 connect input devices, such as keyboard and mouse 743 combinations, a camera 744, or other USB input devices.

In at least one embodiment, an instance of memory controller 716 and platform controller hub 730 may be integrated into a discreet external graphics processor, such as external graphics processor 712. In at least one embodiment, platform controller hub 730 and/or memory controller 716 may be external to one or more processor(s) 702. For example, in at least one embodiment, processing system 700 can include an external memory controller 716 and platform controller hub 730, which may be configured as a memory controller hub and peripheral controller hub within a system chipset that is in communication with processor(s) 702.

In at least one embodiment, the processing system 700 may be used to implement the interconnect devices 100 and/or the processing devices 103 (see FIG. 1). In at least one embodiment, the interconnect devices 100 and/or the processing devices 103 may include one or more of the processor(s) 702, one or more of the processor core(s) 707, and/or one or more of the graphics processor(s) 708. In at least one embodiment, the interface bus 710 may be used to implement the interconnect devices 100 and/or the processing devices 103. In at least one embodiment, one or more systems depicted in FIG. 7 are utilized to implement one or more systems and/or processes such as those described in connection with FIGS. 1-5.

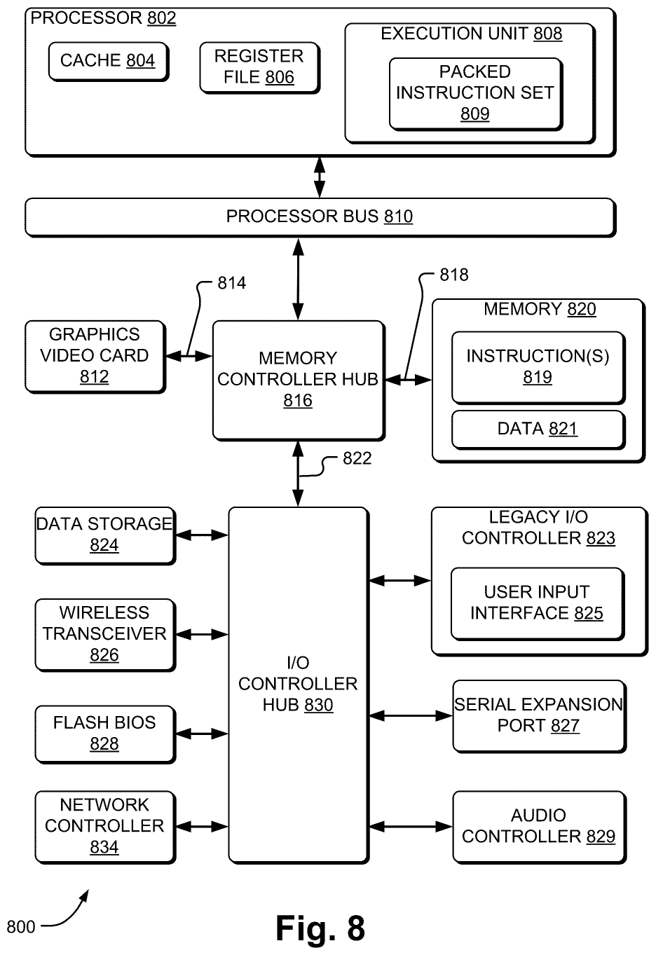

FIG. 8 illustrates a computer system 800, in accordance with at least one embodiment. In at least one embodiment, computer system 800 may be a system with interconnected devices and components, an SOC, or some combination. In at least one embodiment, computer system 800 is formed with a processor 802 that may include execution units to execute an instruction. In at least one embodiment, computer system 800 may include, without limitation, a component, such as processor 802 to employ execution units including logic to perform algorithms for processing data. In at least one embodiment, computer system 800 may include processors, such as PENTIUM® Processor family, Xeon™, Itanium®, XScale™ and/or StrongArm™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 800 may execute a version of WINDOWS' operating system available from Microsoft Corporation of Redmond, Wash., although other operating systems (UNIX and Linux for example), embedded software, and/or graphical user interfaces, may also be used.

In at least one embodiment, computer system 800 may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (DSP), an SoC, network computers (“Net PCs”), set-top boxes, network hubs, wide area network (“WAN”) switches, or any other system that may perform one or more instructions.

In at least one embodiment, computer system 800 may include, without limitation, processor 802 that may include, without limitation, one or more execution units 808 that may be configured to execute a Compute Unified Device Architecture (“CUDA”) (CUDA® is developed by NVIDIA Corporation of Santa Clara, CA) program. In at least one embodiment, a CUDA program is at least a portion of a software application written in a CUDA programming language. In at least one embodiment, computer system 800 is a single processor desktop or server system. In at least one embodiment, computer system 800 may be a multiprocessor system. In at least one embodiment, processor 802 may include, without limitation, a CISC microprocessor, a RISC microprocessor, a VLIW microprocessor, a processor implementing a combination of instruction sets, or any other processor device, such as a digital signal processor, for example. In at least one embodiment, processor 802 may be coupled to a processor bus 810 that may transmit data signals between processor 802 and other components in computer system 800.

In at least one embodiment, processor 802 may include, without limitation, a Level 1 (“L1”) internal cache memory (“cache”) 804. In at least one embodiment, processor 802 may have a single internal cache or multiple levels of internal cache. In at least one embodiment, cache memory may reside external to processor 802. In at least one embodiment, processor 802 may also include a combination of both internal and external caches. In at least one embodiment, a register file 806 may store different types of data in various registers including, without limitation, integer registers, floating point registers, status registers, and instruction pointer register.

In at least one embodiment, execution unit 808, including, without limitation, logic to perform integer and floating point operations, also resides in processor 802. Processor 802 may also include a microcode (“ucode”) read only memory (“ROM”) that stores microcode for certain macro instructions. In at least one embodiment, execution unit 808 may include logic to handle a packed instruction set 809. In at least one embodiment, by including packed instruction set 809 in an instruction set of a general-purpose processor 802, along with associated circuitry to execute instructions, operations used by many multimedia applications may be performed using packed data in a general-purpose processor 802. In at least one embodiment, many multimedia applications may be accelerated and executed more efficiently by using full width of a processor's data bus for performing operations on packed data, which may eliminate a need to transfer smaller units of data across a processor's data bus to perform one or more operations one data element at a time.

In at least one embodiment, execution unit 808 may also be used in microcontrollers, embedded processors, graphics devices, DSPs, and other types of logic circuits. In at least one embodiment, computer system 800 may include, without limitation, a memory 820. In at least one embodiment, memory 820 may be implemented as a DRAM device, an SRAM device, flash memory device, or other memory device. Memory 820 may store instruction(s) 819 and/or data 821 represented by data signals that may be executed by processor 802.

In at least one embodiment, a system logic chip may be coupled to processor bus 810 and memory 820. In at least one embodiment, the system logic chip may include, without limitation, a memory controller hub (“MCH”) 816, and processor 802 may communicate with MCH 816 via processor bus 810. In at least one embodiment, MCH 816 may provide a high bandwidth memory path 818 to memory 820 for instruction and data storage and for storage of graphics commands, data and textures. In at least one embodiment, MCH 816 may direct data signals between processor 802, memory 820, and other components in computer system 800 and to bridge data signals between processor bus 810, memory 820, and a system I/O 822. In at least one embodiment, system logic chip may provide a graphics port for coupling to a graphics controller. In at least one embodiment, MCH 816 may be coupled to memory 820 through high bandwidth memory path 818 and graphics/video card 812 may be coupled to MCH 816 through an Accelerated Graphics Port (“AGP”) interconnect 814.

In at least one embodiment, computer system 800 may use system I/O 822 that is a proprietary hub interface bus to couple MCH 816 to I/O controller hub (“ICH”) 830. In at least one embodiment, ICH 830 may provide direct connections to some I/O devices via a local I/O bus. In at least one embodiment, local I/O bus may include, without limitation, a high-speed I/O bus for connecting peripherals to memory 820, a chipset, and processor 802. Examples may include, without limitation, an audio controller 829, a firmware hub (“flash BIOS”) 828, a wireless transceiver 826, a data storage 824, a legacy I/O controller 823 containing a user input interface 825 and a keyboard interface, a serial expansion port 827, such as a USB, and a network controller 834. Data storage 824 may comprise a hard disk drive, a floppy disk drive, a CD-ROM device, a flash memory device, or other mass storage device.

In at least one embodiment, FIG. 8 illustrates a system, which includes interconnected hardware devices or “chips.” In at least one embodiment, FIG. 8 may illustrate an example SoC. In at least one embodiment, devices illustrated in FIG. 8 may be interconnected with proprietary interconnects, standardized interconnects (e.g., PCIe), or some combination thereof. In at least one embodiment, one or more components of system 800 are interconnected using compute express link (“CXL”) interconnects.

In at least one embodiment, the computer system 800 may be used to implement the interconnect devices 100 and/or the processing devices 103 (see FIG. 1). In at least one embodiment, the interconnect devices 100 and/or the processing devices 103 may include the processor 802 and/or the graphics/video card 812. In at least one embodiment, the processor bus 810 may be used to implement the interconnect devices 100 and/or the processing devices 103. In at least one embodiment, one or more systems depicted in FIG. 8 are utilized to implement one or more systems and/or processes such as those described in connection with FIGS. 1-5.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art. It is to be appreciated that any feature described herein can be claimed in combination with any other feature(s) as described herein, regardless of whether the features come from the same described embodiment.

What is claimed is:

1. A device comprising one or more circuits to:
monitor an amount of traffic traversing one or more ports of the device during a time period;
determine, within the time period, the amount of traffic is greater than and/or equal to a threshold; and
in response to determining the amount of traffic is greater than and/or equal to the threshold, halting traffic traversing the one or more ports of the device until an end of the time period.

2. The device of claim 1, wherein the threshold is a budget of traffic to traverse the one or more ports within the time period.

3. The device of claim 2, wherein the budget of traffic is determined based on a power budget.

4. The device of claim 3, wherein the power budget is received by the device.

5. The device of claim 1, wherein the one or more circuits are further to, after halting the traffic, enter a low-power mode.

6. The device of claim 5, wherein the one or more circuits are further to, at the end of the time period, exit the low-power mode.

7. The device of claim 5, wherein the one or more circuits are further to, prior to entering the low-power mode, determine an amount of time prior to the end of the time period is greater than and/or equal to a second threshold.

8. The device of claim 1, wherein the one or more circuits are further to, upon determining the amount of traffic is greater than and/or equal to the threshold, determine a time remaining within the time period.

9. The device of claim 8, wherein the one or more circuits are further to, based on the time remaining within the time period, determine a type of low-power mode to enter from among a plurality of types of low-power modes.

10. The device of claim 1, wherein the one or more circuits are further to, at the end of the time period, allow traffic to traverse the one or more ports of the device for a second time period.

11. The device of claim 1, wherein monitoring the amount of traffic traversing the one or more ports of the device comprises using a first counter to count a number of packets traversing the one or more ports of the device and a second counter to track an amount of time left in the time period.

12. The device of claim 1, wherein during the time period the one or more ports of the device consume an amount of power equivalent to a power budget associated with the one or more ports for the time period.

13. The device of claim 12, wherein a second power budget is associated with a second one or more ports of the device.

14. A switch, comprising:
one or more communication ports; and
one or more circuits to:
monitor an amount of traffic traversing the switch during a time period;
determine, within the time period, the amount of traffic is greater than and/or equal to a threshold; and
in response to determining the amount of traffic is greater than and/or equal to the threshold, halting traffic traversing the switch until an end of the time period.

15. The switch of claim 14, wherein the threshold is a budget of traffic to traverse within the time period.

16. The switch of claim 15, wherein the budget of traffic is determined based on a power budget.

17. The switch of claim 16, wherein the power budget is received by the switch.

18. The switch of claim 14, wherein the one or more circuits are further to, after halting the traffic, enter a low-power mode.

19. The switch of claim 18, wherein the one or more circuits are further to, at the end of the time period, exit the low-power mode.

20. A computing node comprising one or more circuits to:
monitor an amount of traffic traversing the computing node during a time period;
determine, within the time period, the amount of traffic is greater than and/or equal to a threshold; and
in response to determining the amount of traffic is greater than and/or equal to the threshold, halting traffic traversing the computing node until an end of the time period.
